(19) United States
(12) Patent Application Publication
(10) Pub. No.: US 2024/0240679 A1
(43) Pub. Date: Jul. 18, 2024

(54) BRAKING APPARATUS FOR A MOBILE STORAGE RACK

(71) Applicant: MONTEL INC., Montmagny (CA)

(72) Inventors: Julien CARON, Lévis (CA); William LESSARD, Lévis (CA); Dominic SIMARD, Montmagny (CA)

(21) Appl. No.: 18/411,889

(22) Filed: Jan. 12, 2024

Related U.S. Application Data
(60) Provisional application No. 63/479,834, filed on Jan. 13, 2023.

(51) Int. Cl. F16D 63/00; A47B 53/02; A47B 96/00; F16D 121/14; F16D 127/00; F16D 127/02

(52) U.S. Cl. CPC F16D 63/006; A47B 53/02; A47B 96/00; A47B 2220/0061; F16D 2121/14; F16D 2127/00; F16D 2127/008; F16D 2127/02

(57) ABSTRACT

The mobile storage rack includes a storage rack frame for moving on ground rails, wheels carried by the bottom frame for engaging the ground rails and allowing displacement of the storage rack along the rails, and shelves carried by the frame for supporting articles. The storage rack has a braking apparatus including a unitary braking shaft made of a single shaft segment, a support structure rotatably carrying the braking shaft in cantilevered fashion, the support structure being attached to the storage rack frame, a braking shaft link carried by the braking shaft away from the support structure along the braking shaft, the braking shaft link linking the braking shaft to the storage rack wheels, a triggerable brake actuator that acts on the unitary braking shaft to stop the rotation of the braking shaft when triggered, and a dampener located between the braking actuator and the unitary braking shaft.

### CROSS-REFERENCE TO RELATED APPLICATIONS

This application claims the benefit of U.S. Provisional Application No. 63/479,834, filed on Jan. 13, 2023. The entire disclosure of the above application is incorporated herein by reference.

### FIELD OF THE INVENTION

The invention relates to the field of mobile storage racks that are used in interior mobile storage systems, and more particularly to a braking apparatus for use on a mobile storage rack.

### BACKGROUND OF THE INVENTION

One particular concern in a mobile storage system relates to security. More specifically, when a number of mobile storage racks are simultaneously translated to create an aisle between two contiguous storage racks, another aisle collapses. This means that the horizontal stack of moving storage racks located between the new aisle and the collapsing aisle will move against another storage rack on the other side of the collapsing aisle. If, inadvertently, a person or object were to be located in the collapsing aisle, it may be crushed under the important load of the stack of moving storage racks. This concern is exacerbated by the fact that the person who is controlling the creation of the new aisle might not be located in a way to view the collapsing aisle and might not see or hear anyone standing in the collapsing aisle: this controlling person might be located on the opposite side of the stack of moving storage racks which can be composed of several storage racks.

Security systems for mobile storage systems consequently exist to help avoid accidental impact with, or crushing of, persons or items located in the collapsing aisle. Canadian patent No. 2,545,090 issued in 2010 to the present applicant MONTEL INC. (“the '090 patent”) discloses a security mechanism that includes such a security system, in the form of a braking system for a mobile storage rack.

Canadian patent No. 2,545,090 more particularly discloses a storage rack having a driving mechanism that in turn comprises a braking system. The storage rack comprises a bottom frame rotatably carrying driving wheels that engage floor rails. The driving mechanism comprises a toothed wheel rotatably carried by the frame that is operatively connected to the driving wheels and that rotates in synchronism therewith, and defines a first interlock member. The driving mechanism also comprises a gravity-biased braking member defining a second interlock member. The braking member is movably mounted to the frame so as to be movable between a standby position in which the second interlock member clears the first interlock member, and a braking position in which the second interlock member is interlocked with the first interlock member to block rotation of the rotary first braking member and thus of the driving wheel. The braking member is biased under the action of gravity towards its braking position when it is in its standby position.

The driving mechanism further comprises a brake control member mounted to the frame, that includes a kick plate. The brake control member is movable between a retaining position in which the brake control member engages and retains the braking member in its standby position against the bias of gravity, and a release position in which it clears the braking member to allow gravity-borne movement of the braking member towards the braking position. When the kick plate is pushed, e.g., by the foot or a person standing in a collapsing aisle kicking the kick-plate, the brake control member is moved from its retaining to its release position, to thereby allow the braking member to move into its breaking position.

In the '090 patent, there is further disclosed that the shaft of the toothed wheel is divided into a plurality of coaxial shaft portions or segments, that are coupled to each other by torsion-absorbing coupling members that act as dampeners. Each toothed wheel of the braking system is mounted to one shaft portion while the driving wheels 19 are operatively coupled to other distinct shaft portions with gear and chain assemblies.

The purpose of the dampeners is to avoid the storage rack from coming to an abrupt stop when a person hits the kick plate to stop the storage rack from moving. Indeed, although the braking system will abruptly prevent one shaft section from rotating, the intervening torsion dampener will in fact absorb part of that abrupt rotational torsional force to dampen the transmission of this movement to the other shaft portion that is linked to the drive wheels. This means that the drive wheels will stop rotating somewhat gradually, before moving back a bit as the dampener rotates back to its resting position. This helps prevent objects stored on the shelves of the storage rack from sliding off the shelves onto the ground, including on the person that hit the kick plate, when the kick-plate is kicked.

A problem with the '090 patent is that the fragmented shaft of the braking system requires installation and support of its shaft segments on more than one spaced-apart portions of the bottom frame of the storage rack. More particularly, each segment of the shaft of the braking system that is located on either side of a torsion dampener needs to be carried by a pair of spaced-apart respective supports (e.g., with ball bearings) to ensure that the shaft segments remain aligned. Such an installation takes up space on the storage rack: for each pair of shaft segments separated by a torsion dampener, two pairs of supports are installed each on a respective structure of the storage rack bottom frame. This space means that the bottom frame of the storage needs to have several suitably positioned structures to support these shaft segments; or additional support structures must be added to the existing storage rack bottom frame.

This is counter to the present trend in mobile storage systems where less structure and weight on the frame of the storage rack is desired. This also makes installation of the braking system more complex and time consuming, as it requires more attachments to the storage rack bottom frame. The installation of this prior art system can be especially challenging when the braking system is being retrofitted on an existing storage rack, if the frame of the storage rack does not have a structure that is compatible for supporting the distinct shaft segments of the braking system.

### SUMMARY OF THE INVENTION

Accordingly, the present invention provides for a braking apparatus that is easier to install and requires less support structure on the storage rack to carry it. It is further less time consuming and less expensive to install. One advantage of the braking apparatus of the present invention is that it may be installed at a single position on the storage rack frame, instead of requiring pairs of supports structures to be disposed on either side of the braking apparatus to support it.

More specifically, the present invention relates to a braking apparatus for a mobile storage rack that has a displacement device that allows the displacement of the storage rack, said braking apparatus comprising:
a unitary braking shaft made of a single shaft segment;
a support structure rotatably carrying said braking shaft in cantilevered fashion, said support structure for attachment to the storage rack;
a braking shaft link carried by said braking shaft away from said support structure along said braking shaft, for linking said braking shaft to the displacement device of the storage rack;
a triggerable brake actuator that acts on said unitary braking shaft to stop the rotation of said braking shaft when triggered, for consequently also stopping the movement of the mobile storage rack when said braking shaft stops rotating; and
a dampener located between said braking actuator and said unitary braking shaft.

In one embodiment, said brake actuator comprises a gear wheel mounted to said braking shaft away from said support structure and away from said braking shaft link along said braking shaft; and a stop member triggerable to engage said gear wheel to stop the rotation thereof, with said dampener being installed between said gear wheel and said braking shaft.

In one embodiment, said dampener is a resilient ring located exteriorly of said braking shaft and interiorly of said gear wheel.

In one embodiment, said resilient ring is encased within interior and exterior rigid rings of said gear wheel.

In one embodiment, said stop member comprises at least one braking finger carried by said support structure and movable between a braking position in which it engages said gear wheel to stop the rotation of said gear wheel, and a released position in which it does not engage said gear wheel and said gear wheel is allowed to rotate, a first biasing member continuously biasing said at least one braking finger towards said braking position, a second biasing member continuously biasing said at least one braking finger towards said released position against the action of said first biasing member, and a release mechanism that, when actuated, releases said second biasing member thereby allowing said braking member to move towards said braking position under the action of said first biasing member.

In one embodiment, said first biasing member comprises said braking finger's own weight forcing said braking finger towards said breaking position under gravity and said second biasing member includes a spring forcing said braking finger towards said released position.

In one embodiment, said stop member further comprises a user-actionable trigger device for mounting to the storage rack, said trigger device linked to said release mechanism to actuate said release mechanism to when triggered.

In one embodiment, said trigger device comprises a kick plate for mounting along a bottom edge of the storage rack.

The present invention also relates to a mobile storage rack for use in a mobile storage system, comprising:
a storage rack frame for moving on ground rails;
wheels carried by said bottom frame, for engaging said ground rails and allowing displacement of said storage rack along said rails;
shelves carried by said frame for supporting articles; and
a braking apparatus comprising:
   a unitary braking shaft made of a single shaft segment;
   a support structure rotatably carrying said braking shaft in cantilevered fashion, said support structure being attached to said storage rack frame;
   a braking shaft link carried by said braking shaft away from said support structure along said braking shaft, said braking shaft link linking said braking shaft to said storage rack wheels;
   a triggerable brake actuator that acts on said unitary braking shaft to stop the rotation of said braking shaft when triggered and also consequently of the movement of the mobile storage rack; and
   a dampener located between said braking actuator and said unitary braking shaft.

### BRIEF DESCRIPTION OF THE DRAWINGS

In the annexed drawings:

FIG. 1 is a perspective view of a mobile storage rack installed on ground rails that are schematically shown;

FIG. 2 is an enlarged partial perspective view of the mobile storage rack of FIG. 1 showing one end of the bottom frame and drive mechanism of the storage rack together with part of the overlying shelf support structure and the nearby schematic-depicted ground rails;

FIG. 3 is an enlarged perspective view of the area circumscribed by line III in FIG. 2;

FIG. 4 is an enlarged perspective view of the area circumscribed by line IV in FIG. 3, with the cover of the breaking apparatus housing being removed to show underlying components;

FIG. 5 is a side elevation of the elements shown in FIG. 3;

FIG. 6 is a cross-sectional view taken along line VI-VI of FIG. 5;

FIGS. 7 and 8 are partial perspective views of the braking apparatus of FIGS. 3-6, at a slightly enlarged scale, with the cover of the housing being removed to show the underlying components;

FIG. 9 is a side elevation of the braking wheel of the braking apparatus of FIGS. 3-8;

FIG. 10 is a cross-sectional view taken along line X-X of FIG. 9; and

FIG. 11 is a perspective view of the braking wheel of FIG. 9.

### DETAILED DESCRIPTION OF THE EMBODIMENTS

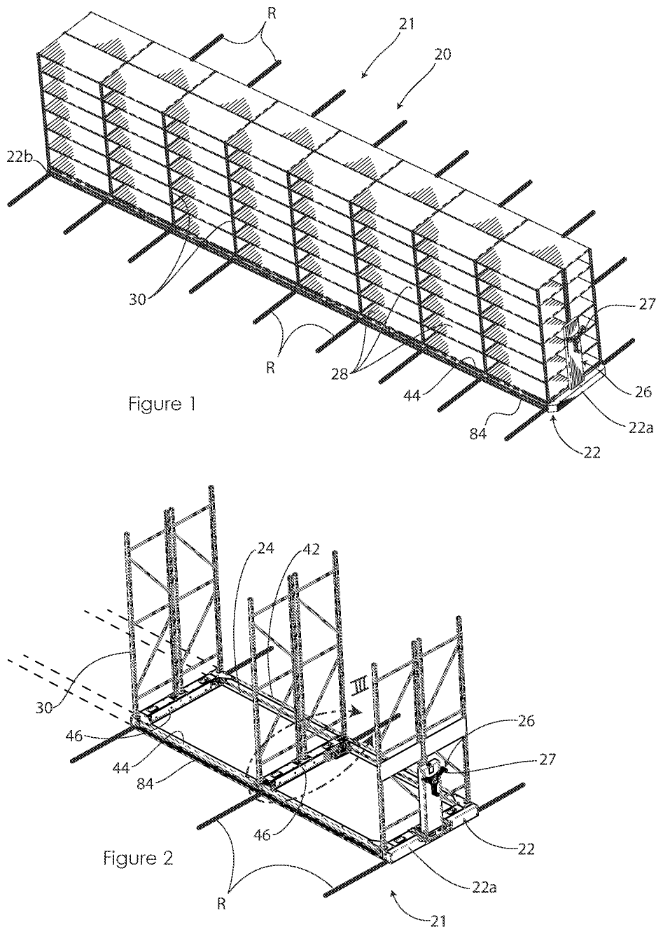

FIG. 1 shows a mobile storage rack 20 for use in a mobile storage system 21 to be installed in an interior warehouse or other storage facility. As shown in FIGS. 1 and 2, rack 20 comprises a bottom frame 22 that is movable over ground on a number of ground rails R that are fixedly attached to the ground. Rails R are preferably embedded in the ground, within grooves provided in the floor, to avoid the rails from protruding above floor level. Several wheels 25a, 25b that are carried by bottom frame 22 engage rails R and allow rack 22 to roll in either direction along rails R. The wheels include a number of drive wheels 25a that are linked to a drive shaft 24, and idle wheels 25b that are simply rotatably supported by bottom frame 22. Drive shaft 24 is in turn operatively linked to a control mechanism 26 in a known manner, e.g., through suitable gears, chains, or other suitable linkages. Control mechanism 26 is shown to include a manually operable rotatable handle 27 to move the mobile storage rack 20 along rails R, but other known devices may be used to control the movement of storage rack 20, for example a computer linked to an electric drive mechanism and one or more user terminals allowing users to control the displacement of mobile storage rack 20. When control mechanism 26 is actuated by rotating the handle 27, drive shaft 24 will be brought into rotation by its operative connexion to control mechanisms 26, which in turn will rotate the drive wheels 25a of the storage rack 20 to move storage rack 20 along rails R. If handle 27 is turned in one direction, storage rack 22 will be translated along a corresponding first direction along rails R; and if handle 27 is turned in the opposite direction, storage rack 22 will be translated along a corresponding second direction, opposite the first direction, along rails R.

Atop bottom frame 22 are installed a number of shelves 28 carried by a shelf support structure 30 which rests on bottom frame 22. Shelves 28 may support objects to be stored or disposed in a suitable manner on shelves 28 such as trays, boxes, plants, or the like.

Mobile storage system 21 may include a number of additional storage racks (not shown) that are also movable along rails R. As known in the field of movable storage systems, storage rack 20 and the additional storage racks can be horizontally stacked against each other, except at one position where an aisle will be created by spacing apart two contiguous storage racks. For creating an aisle, the drive mechanism 26 of any one of the storage racks may be activated, which will force that storage rack and any other storage rack downstream of its translational movement direction to move, until that stack of storage racks abuts against a wall, a fixed storage rack or another fixed structure. Normally, the creation of an aisle is made possible by another aisle collapsing, i.e., a horizontal stack of storage racks moves of a distance equal to the width of an aisle located downstream of the movement of that stack of storage racks, with a new aisle being gradually created as the previous aisle collapses and with the horizontal stack of storage racks moving of a distance equal to the collapsing aisle.

An aisle may consequently be formed at any position between any pair of contiguous storage racks, while the other storage racks will be horizontally stacked on either side of the thusly formed aisle.

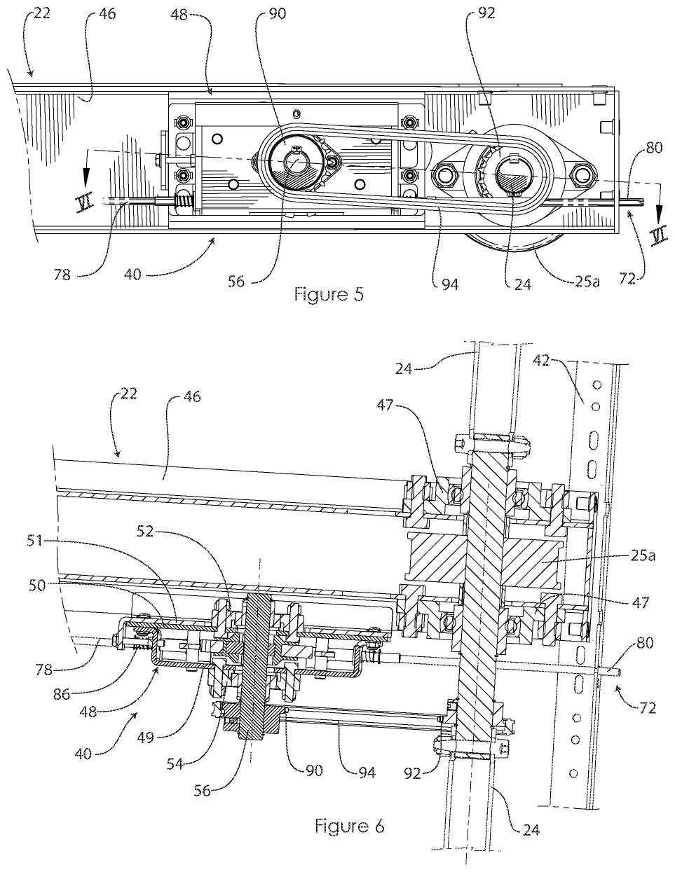

FIGS. 2-6 show that bottom frame 22 comprises a pair of spaced-apart girders 42, 44 that extend from one end 22a to the other 22b of storage rack 20. Crossbars 46 link girders 42, 44. Drive wheels 25a are carried by drive shaft 24 as mentioned above, each within a corresponding crossbar 46. Drive shaft 24 extends through and is rotatably carried by crossbars 46 by means of drive shaft ball bearing supports 47.

Storage rack system 21 could instead include storage racks (not shown) of different design or configuration, as will be obvious to a person skilled in the art. For instance, some mobile storage racks move over ground without resting on rails, and the present invention is intended to be usable on such mobile storage racks also.

According to the present invention, and as shown in FIG. 2, storage rack 20 comprises a pair of braking apparatuses 40 that are each installed on bottom frame 22 of storage rack 20. Although two braking apparatuses 40 are shown, it is understood that storage rack 20 could be equipped with a single one, or more than two.

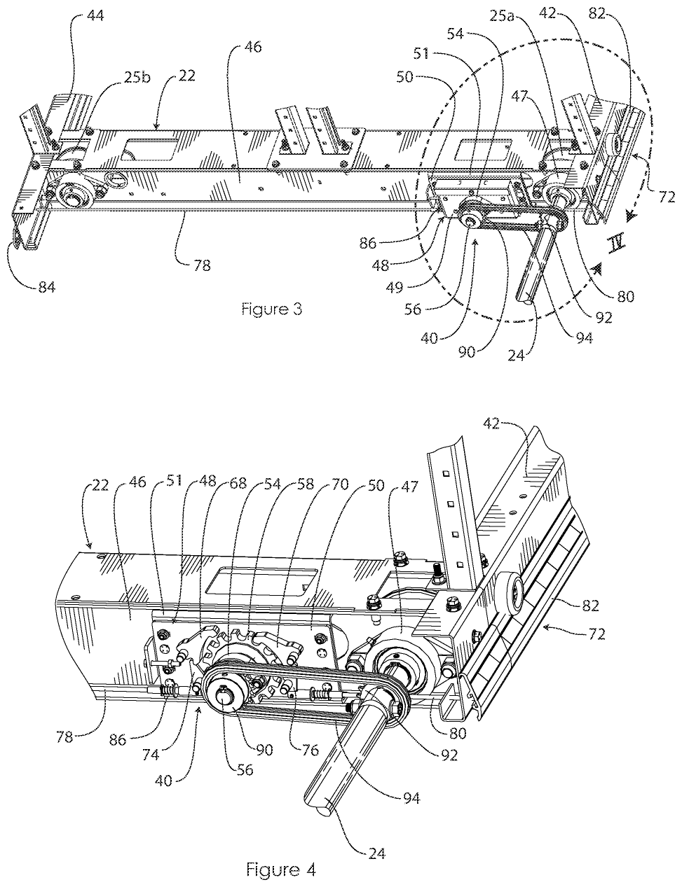

FIGS. 3-8 show that braking apparatus 40 is carried by one crossbar 46 close to a corresponding drive wheel 25a—although this closeness is not strictly necessary, it allows for less stress being imparted to the different frame, drive, and braking components.

Braking apparatus 40 more particularly comprises a support structure in the form of a housing 48 that includes an attachment plate 51 fixedly attached to crossbar 46, a back plate 50 attached to attachment plate 51, and a cover 49 attached to back plate 50. Housing 48 carries a pair of ball bearings 52, 54 that are attached on either side of it. Ball bearings 52, 54 rotatably carry a braking shaft 56 that loosely extends through openings made in housing 48 to accommodate braking shaft 56. Braking shaft 56 is carried by back plate 50 in cantilevered fashion, and it extends away from one crossbar 46 but is not attached to another crossbar 46 at its second end. Braking shaft 56 is unitary, it is made of a single shaft segment, as opposed to prior art braking shafts such as the one shown in the '090 patent that are made of two or more distinct shaft segments linked by a dampener.

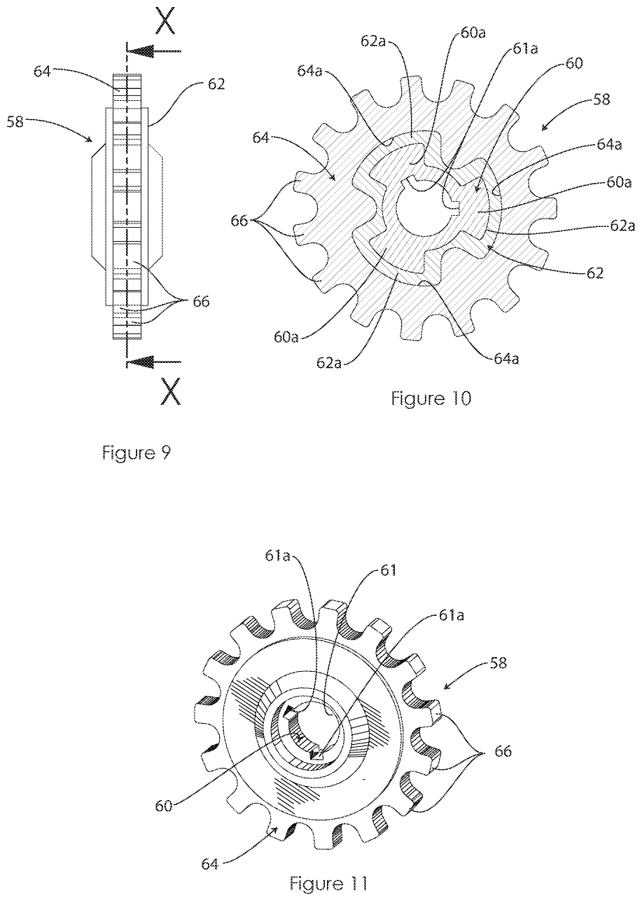

Braking shaft 56 carries triggerable brake actuator that comprises a toothed torsion-dampening braking wheel 58 that is located within housing 48. Braking wheel 58 is also shown in FIGS. 9-11. It comprises a rigid core 60 that fixedly engages braking shaft 56 such that they will rotate as one. More specifically, rigid core 60 has an inner bore 61 that is engaged by braking shaft 56, with notches 61a being made in the periphery of bore 61 to be engaged by corresponding tabs (not shown) of braking shaft 56 to prevent relative rotation of shaft 56 with respect to rigid core 60.

A resilient ring 62 engages and encases rigid core 60, with respective complementary tabs 60a, 62a being provided on core 60 and resilient ring 62 to prevent relative movement of one with respect to the other. A rigid outer toothed ring 64 is provided radially outwardly of resilient ring 62, with openings 64a within it to receive tabs 62a of resilient ring 62 to prevent relative movement of one with respect to the other. Toothed ring 64 comprises a number of radially extending teeth 66 on its outer periphery.

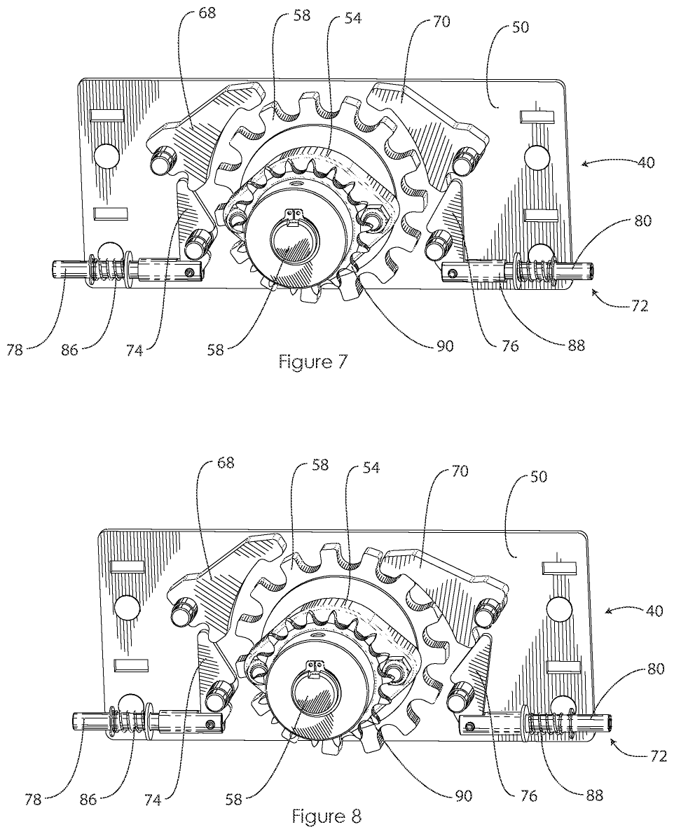

The braker actuator further comprises a stop member in the form of braking fingers 68, 70 that are pivotally carried by and within housing 48 and that are engageable against the toothed outer periphery of braking wheel 58. Fingers 68, 70 are each pivotable between a released position shown in FIGS. 4, 7 and 8 for finger 68 and in FIGS. 4 and 7 for finger 70, where fingers 68, 70 are spaced from and do not engage the teeth 66 of braking wheel 58; and a braking position shown in FIG. 8 for finger 70, where fingers 68, 70 engage with their tip between teeth 66 to block the rotation of braking wheel 58.

Fingers 68, 70 are continuously biased under gravity towards their braking position, but a release mechanism 72 normally prevents them from reaching their braking position. More particularly, release mechanism 72 comprises a pair of intermediate pivots 74, 76 each pivotally carried by and within housing 48 such that they are pivotable between a first position where they push on a bottom portion of a corresponding finger 68, 70 to maintain them in their released position against the action of gravity; and a second position where they release their corresponding finger 68, 70 to allow them to pivot into their braking position under gravity. Link bars 78, 80 are respectively connected to intermediate pivots 74, 76 and extend away from housing 48, each through a respective one of girders 42, 44 and outwardly of bottom frame 22.

Braking apparatus 40 also comprises a pair of kick plates 82, 84 (FIGS. 2-4) provided each along a respective girder 42, 44. Kick plates 82, 84 are pivotally attached to bottom frame 22 along a respective girder 42, 44 so as to pivot between an outer position shown in FIGS. 3-4 where they are pivoted away from bottom frame 22 and an inner position (not shown in the drawings) where they are pivoted towards bottom frame 22. The extremity of link bars 78, 80 abuts against kick plates 82, 84. Biasing members in the form of coil springs 86, 88 that are tensioned against the outer wall of housing 48 continuously bias link bars 78, 80 away from housing 48, which in turn continuously biases:
a) intermediate pivots 72, 74 towards their first position to force braking fingers 68, 70 into their released position; and
b) kick plates 82, 84 towards their outer position.

Braking shaft 56 further carries a first gear wheel 90, outwardly of housing 48, that rotates as one with braking shaft 56. Drive shaft 24 carries a second gear wheel 92 that rotates as one with drive shaft 24. First gear wheel 90 is operatively linked to second gear wheel 92 by means of a chain 94 such that first and second gear wheel 90, 92, and hence drive shaft 24 and braking shaft 56, all rotate simultaneously and in a same direction.

In use, braking apparatus 40 normally is in a released state that does not impede the movement of storage rack 20, allowing storage rack 20 to always roll in both directions along rails R, except as described hereinafter. In this released state of braking apparatus, coil springs 86, 88 bias kick plates 82, 84 into their outer position and braking fingers 68, 70 into their released position, as mentioned hereinabove. Fingers 68, 70 are consequently maintained in their released position.

While storage rack 20 moves along rails, drive shaft 24 rotates concurrently with drive wheels 25a—either as a result of drive mechanism 26 being actuated or under the inertia of storage rack 20 moving along rails R. The rotation of drive shaft 24 is transmitted by second gear wheel 92, chain 94 and first gear wheel 90, to braking shaft 56 that consequently also rotates whenever drive shaft 24 rotates. While braking fingers 68, 70 remain in their released position, they do not act on braking wheel 58 and braking apparatus 40 does not impede the movement of storage rack 20.

As a security measure, mobile storage rack 20 may be stopped in its advance along rails R whenever the kick plate 82, 84 that is located on the upstream side of the moving storage rack 20, for example kick plate 82, is pushed towards bottom frame 22. Kick plate 82 may be pushed for example by a user using their foot or other body portion to kick the kick plate 82, or even by an item lying on the ground being impacted by kick plate 82. Pushing kick plate 82 towards bottom frame 22 will translate link bar 80 towards housing 48 against the action of coil spring 88, which will in turn pivot intermediate pivot 76 from its first into its second position. This will release braking finger 70 which will pivot under gravity from its released position into its braking position wherein its tip falls in between two teeth 66 of braking wheel 58. Braking finger 70 will then act as a stop as the tangential push of one tooth 66 against braking finger 70 will be aligned with the pivot of braking finger 70.

When braking finger 70 is inserted between the teeth 66 of braking wheel 58, the rotation of outer ring 64 of braking wheel 58 will be abruptly stopped, while braking shaft 56 was heretofore rotating. The resilient ring 62 of braking wheel 58 will then resiliently deform between:
a) the rotating braking shaft 56 together with rigid core 60, and
b) the rigid outer toother ring 64.

Resilient ring 62 will more particularly deform in the tangential space between tabs 60a of rigid core 60 and the inner walls of the openings 64a of the rigid outer ring 64, when outer ring 64 is brought to an abrupt stop by finger 70. Concurrently, the rotation of rigid core 60 and of braking shaft 56 will gradually stop, which in turn will bring the rotation of drive shaft 24 and of drive wheels 25a to a gradual stop also. Consequently, the translation of storage rack 20 along rails R will come to a gradual stop, as opposed to an abrupt stop. It is understood that the deformation of resilient ring 62 thus acts as a dampener to allow this gradual stop. Resilient ring 62 will then, under its own resiliency, force rigid core 60, braking shaft 56, drive shaft 24 and drive wheels 25a to rotate in the opposite direction slightly, until resilient ring 62 resiliently recuperates its undeformed shape. This will move storage rack 20 back slightly after it is stopped.

It is understood that kick plate 84 on the opposite side of storage rack 20 may be used to stop the movement of storage rack 20 in the opposite direction, in a similar way as described above, albeit using of course the link bar 78, intermediate pivot 74 and braking finger 68 on the same side as kick plate 84.

The braking action of braking apparatus 40 is instantaneous, such that the security of the person standing in the collapsing aisle is ensured. Whenever kick plates 82, 84 are released, braking fingers 68, 70 are forced into their released position by the action of coil springs 86, 88, which allows storage rack to move normally along rails R once again.

One advantage of the braking apparatus 40 for a storage rack 20 according to the present invention is that it may be installed on a single structural element of bottom frame 22, namely, on a single crossbar 46. This is allowed by the configuration of braking shaft 56 which is made of a single, unitary piece, as opposed to having two or more distinct segments as in the '090 patent. The inclusion of the dampening resilient ring 62 within the braking wheel 58, as opposed to being installed between segments of the braking shaft as in the '090 patent, allows for the braking shaft 58 to be unitary.

Having braking apparatus 40 carried at a single position of bottom frame 22, or more generally, at a single position of storage rack 20, has a few advantages. Firstly, this allows for braking apparatus to be much smaller: it does not need to extend between two structural components, such as between two spaced-apart crossbars 46. In some instances where two spaced-apart crossbars 46 were not available in prior art devices, the prior art '090 patent apparatus required the addition of structural components for the prior art braking apparatus to be installed. This is not required with the braking apparatus 40 of the invention. This further allows braking apparatus 40 to be retrofitted much more easily on existing mobile storage racks. It is also simpler and less expensive to instal. The unitary braking shaft 58 may be supported by a single support structure such as housing 48, which makes retrofitting it onto an existing storage rack easy.

Also, each crossbar 46 and the wheels 25a, 25b that it carries together form a trolley that is light-weight compared to the prior art mobile racks where heavier crossbars and support structures were used. This lighter structure for the storage rack 20, together with having fewer crossbars 46 and a braking system 40 that may be installed on a single crossbar 46, cooperate to provide a lighter storage rack 20—which is advantageous for cost, operation, and usability.

1. A braking apparatus for a mobile storage rack that has a displacement device that allows the displacement of the storage rack, said braking apparatus comprising:
a unitary braking shaft made of a single shaft segment;
a support structure rotatably carrying said braking shaft in cantilevered fashion, said support structure for attachment to the storage rack;
a braking shaft link carried by said braking shaft away from said support structure along said braking shaft, for linking said braking shaft to the displacement device of the storage rack;
a triggerable brake actuator that acts on said unitary braking shaft to stop the rotation of said braking shaft when triggered, for consequently also stopping the movement of the mobile storage rack when said braking shaft stops rotating; and
a dampener located between said braking actuator and said unitary braking shaft.

2. The braking apparatus as defined in claim 1, wherein said brake actuator comprises a gear wheel mounted to said braking shaft away from said support structure and away from said braking shaft link along said braking shaft; and a stop member triggerable to engage said gear wheel to stop the rotation thereof, with said dampener being installed between said gear wheel and said braking shaft.

3. The braking apparatus as defined in claim 2, wherein said dampener is a resilient ring located exteriorly of said braking shaft and interiorly of said gear wheel.

4. The braking apparatus as defined in claim 3, wherein said resilient ring is encased within interior and exterior rigid rings of said gear wheel.

5. The braking apparatus as defined in claim 2, wherein said stop member comprises at least one braking finger carried by said support structure and movable between a braking position in which it engages said gear wheel to stop the rotation of said gear wheel, and a released position in which it does not engage said gear wheel and said gear wheel is allowed to rotate, a first biasing member continuously biasing said at least one braking finger towards said braking position, a second biasing member continuously biasing said at least one braking finger towards said released position against the action of said first biasing member, and a release mechanism that, when actuated, releases said second biasing member thereby allowing said braking member to move towards said braking position under the action of said first biasing member.

6. The braking apparatus as defined in claim 5, wherein said first biasing member comprises said braking finger's own weight forcing said braking finger towards said breaking position under gravity and said second biasing member includes a spring forcing said braking finger towards said released position.

7. The braking apparatus as defined in claim 5, wherein said stop member further comprises a user-actionable trigger device for mounting to the storage rack, said trigger device linked to said release mechanism to actuate said release mechanism when triggered.

8. The braking apparatus as defined in claim 7, wherein said trigger device comprises a kick plate for mounting along a bottom edge of the storage rack.

9. A mobile storage rack for use in a mobile storage system, comprising:
a storage rack frame for moving on ground rails;
wheels carried by said bottom frame, for engaging said ground rails and allowing displacement of said storage rack along said rails;
shelves carried by said frame for supporting articles; and
a braking apparatus comprising:
a unitary braking shaft made of a single shaft segment;
a support structure rotatably carrying said braking shaft in cantilevered fashion, said support structure being attached to said storage rack frame;
a braking shaft link carried by said braking shaft away from said support structure along said braking shaft, said braking shaft link linking said braking shaft to said storage rack wheels;
a triggerable brake actuator that acts on said unitary braking shaft to stop the rotation of said braking shaft when triggered and also causing movement of the mobile storage rack; and
a dampener located between said braking actuator and said unitary braking shaft.

10. The mobile storage rack as defined in claim 9, wherein said brake actuator comprises a gear wheel mounted to said braking shaft away from said support structure and away from said braking shaft link along said braking shaft; and a stop member triggerable to engage said gear wheel to stop the rotation thereof, with said dampener being installed between said gear wheel and said braking shaft.

11. The mobile storage rack as defined in claim 10, wherein said dampener is a resilient ring located exteriorly of said braking shaft and interiorly of said gear wheel.

12. The mobile storage rack as defined in claim 11, wherein said resilient ring is encased within interior and exterior rigid rings of said gear wheel.

13. The mobile storage rack as defined in claim 10, wherein said stop member comprises at least one braking finger carried by said support structure and movable between a braking position in which it engages said gear wheel to stop the rotation of said gear wheel, and a released position in which it does not engage said gear wheel and said gear wheel is allowed to rotate, a first biasing member continuously biasing said at least one braking finger towards said braking position, a second biasing member continuously biasing said at least one braking finger towards said released position against the action of said first biasing member, and a release mechanism that, when actuated, releases said second biasing member thereby allowing said braking member to move towards said braking position under the action of said first biasing member.

14. The mobile storage rack as defined in claim 13, wherein said first biasing member comprises said braking finger's own weight forcing said braking finger towards said breaking position under gravity and said second biasing member includes a spring forcing said braking finger towards said released position.

15. The mobile storage rack as defined in claim 13, wherein said stop member further comprises a user-actionable trigger device for mounting to the storage rack, said trigger device linked to said release mechanism to actuate said release mechanism when triggered.

16. The mobile storage rack as defined in claim 15, wherein said trigger device comprises a kick plate for mounting along a bottom edge of the storage rack.
